(19) United States
(12) Patent Application Publication
(10) Pub. No.: US 2024/0266845 A1
(43) Pub. Date: Aug. 8, 2024

(54) BIPOLAR STORAGE BATTERY SYSTEM

(71) Applicant: COMMEO GMBH, Wallenhorst (DE)

(72) Inventors: Michael SCHNAKENBERG, Wallenhorst (DE); Guido SCHMÜLLING, Wallenhorst (DE); Florian OTTE, Wallenhorst (DE)

(21) Appl. No.: 18/561,505

(22) PCT Filed: Jun. 3, 2022
(86) PCT No.: PCT/EP22/65238

§ 371 Date: Nov. 16, 2023

(30) Foreign Application Priority Data
Jun. 7, 2021 (DE) 10 2021 205 732.2

(51) Int. Cl. H02J 7/00; H01M 10/0525; H01M 50/209; H01M 50/211; H01M 50/213; H01M 50/51; H02J 9/06

(52) U.S. Cl. CPC H02J 7/0029; H01M 10/0525; H01M 50/209; H01M 50/211; H01M 50/213; H01M 50/51; H02J 7/0013; H02J 7/0047; H02J 9/06; H02J 2207/20

(57) ABSTRACT

The invention relates to a bipolar storage battery system (10) comprising two storage battery units (12, 14), each including at least one storage battery module (16), and a shared control unit (20) for the two storage battery units (12, 14), the two storage battery units (12, 14) being connected in series by means of corresponding contacts (12-2, 14-1), and a center tap (18) resulting from the connection, and the contacts (12-1, 14-2) remaining after the connection, as a positive pole and negative pole, and the center tap (18) as a neutral pole, of the storage battery system (10) each being routed across the control unit (20) to the outside.

### BACKGROUND OF THE INVENTION

### 1. Field of the Invention

The invention relates to a bipolar storage battery system, which may also be referred to as a bipolar battery system. The terms “storage battery system” and “battery system” are synonymous. The storage battery system is a bipolar storage battery system, i.e., a storage battery system which at corresponding external terminals simultaneously provides a positive voltage and a negative voltage relative to a common ground potential, for example +300 V and −300 V.

### 2. Description of Related Art

A battery device, referred to therein as “battery pack,” having three taps is known from US 2006/0071636 A1, namely, FIG. 1 thereof.

A bipolar storage battery system has various advantages over a conventional unipolar storage battery system.

“Unipolar” means “single-pole” in relation to a zero point, and a corresponding storage battery system has two external terminals/external contacts (two-pole system). “Bipolar” means “two-pole” in relation to a zero point, and a corresponding storage battery system has three external terminals/external contacts (three-pole system).

A storage battery system includes storage battery cells that may optionally be combined to form storage battery modules, storage battery units, or the like, and, for example, a control and switch-off unit (CSU) (or also switch-off and control unit), sometimes referred to as “control unit” for short; lithium cells by necessity always include at least one control unit, and lead cells, for example, routinely likewise include a control unit or a type of control unit. Such a control unit, which also optionally includes distributed components, is absolutely necessary for ensuring the electrical and functional safety of the storage battery system, and in general for ensuring the product safety of the storage battery system (US 2006/0071636 A1 provides an example of such a functionality in the form of the device, referred to therein as a controller; DE 10 2017 210 615 A likewise describes such a functionality, referred to therein as a control unit). This necessity applies all the more for a storage battery system that includes storage battery cells in the form of lithium cells (lithium-ion storage battery cells); for the latter, it is known that the manner in which energy is stored in such a storage battery cell is associated with a slight, but not entirely negligible, risk of fire, or at least the risk of release of hot and possibly combustible gases. There is also the risk of thermal runaway of a storage battery cell. For a storage battery system with a plurality of storage battery cells, there is the further risk that a thermal runaway of one storage battery cell affects other neighboring storage battery cells, resulting in a potentially hazardous chain reaction, or at least in a significant increase in the quantity of very hot gases that escape. This is referred to as propagation from storage battery cell to storage battery cell. Comparatively complicated metrological monitoring of each storage battery cell or a group (cell block) or multiple groups of storage battery cells is therefore necessary. This monitoring takes place by means of the control unit and a sensor system, the control unit receiving signals from the sensor system and performing monitoring, and triggering switch-off responses or error responses if necessary. This applies in principle for any possible embodiment of storage battery cells, but particularly preferably for storage battery cells in the form of lithium cells.

A storage battery system of the type proposed here, and in general basically all storage battery systems, come(s) into consideration in particular for use as an electrical energy source in the event of a power failure or an insufficient or fluctuating power supply voltage. The storage battery system then functions, for example, as an uninterruptible power supply (UPS), or uninterruptible voltage supply (UVS), or in general as a substitute power supply (SPS) or an emergency power system, or as a component of a UPS or SPS.

Practically all power grids worldwide operate with unipolar alternating voltage. One pole forms the zero point, and the voltage at the second pole cyclically alternates at a certain frequency (typically 50 Hz or 60 Hz) from a positive maximum value to a negative maximum value, for example from approximately +220 V to approximately −220 V.

For use of a storage battery system as a UPS, SPS, or the like, such an alternating voltage, the particular power system voltage, must be simulated by means of the potentials that are tappable for the storage battery system. In a unipolar storage battery system, for generating an alternating voltage from the exactly two potentials provided from the storage battery system, it is common to regularly exchange the assignment of the external terminals of the inverter with the external terminals of the unipolar storage battery system, as is known, for example, for circuits in the form of so-called H-bridges or the like. This interchanging of the assignment is extremely lossy and thus very inefficient.

In addition, this requires a comparatively complex circuit and components having high electric strength. However, if two poles and a zero point are available at corresponding external terminals, as is the case for a bipolar storage battery system, such interchanging of the assignment is not necessary for generating an alternating voltage. Rather, it is necessary only to connect or disconnect one of the poles in alternation. This allows a circuit with fewer losses and fewer disturbances, as well as a greatly simplified circuit due to the fact that the zero point potential may be used as a reference potential for control processes on the part of the downstream inverter.

One known option for obtaining a bipolar storage battery system lies in a connection of two unipolar storage battery systems, namely, an in particular serial connection of these unipolar storage battery systems to obtain a shared zero point for the connection. With a serial connection, the unipolar storage battery systems are connected with an opposite polarity, i.e., plus and minus or minus and plus, and the remaining poles form the external terminals of the (two-pole) connection of the resulting two-pole system.

The disadvantage of such a connection is that each of the two unipolar storage battery systems typically requires its own control and switch-off unit (CSU), which results in increased complexity of circuits and components. In addition, the bipolarity results only outside the two storage battery systems. None of the storage battery systems that are connected for obtaining bipolarity are themselves bipolar. These storage battery systems are, and remain, unipolar.

With such a connection, there is a further disadvantage, which in practice is often much more serious, that a provider of such a connection (external connection of two unipolar systems to form a bipolar system) becomes the manufacturer of the resulting connection, and therefore is naturally also responsible for its electrical and functional safety, and in general for product safety. It is easier and much more favorable for a system manufacturer who combines a bipolar storage battery system, in particular a bipolar storage battery system of the type proposed here, with an inverter and the like connected downstream, for example to form a UPS, SPS, or the like, when, as a storage battery system, it is supplied with a finished, immediately usable, intrinsically safe bipolar battery system having three external terminals; i.e., the bipolar storage battery system is available, in a manner of speaking, as a type of black box, and with an ensured and defined function and product safety.

### SUMMARY OF THE INVENTION

The object of the invention proposed here is to provide a simple bipolar storage battery system which avoids or at least reduces the disadvantages in the prior art, and in particular also takes into account the above-described integration concept, i.e., in particular to provide a bipolar storage battery system that is easier and more economical to integrate into an overall system, for example an overall system that functions as a UPS, SPS, or the like.

In the broadest sense, a storage battery system of the type proposed here is a combination of two unipolar storage battery units, as such, to obtain a bipolar storage battery system on the output side. The term “storage battery units” encompassed by the bipolar storage battery system is essentially a term for differentiation. Such a storage battery unit itself is essentially a storage battery system, but is unipolar. Each storage battery unit includes at least one storage battery module, and each storage battery module includes at least one storage battery cell (rechargeable battery cell). A storage battery cell is a single storage element, and along a hierarchy of the terms used here (storage battery system, storage battery unit, storage battery module, storage battery cell) is the smallest energy storage unit of the system.

For example, so-called round cells, pouch cells, prismatic cells, and the like are suitable as storage battery cells. The storage battery cells are preferably lithium-ion storage battery cells, in particular storage battery cells based on lithium transition metal oxides or phosphates, and graphitic carbon.

The object stated above is achieved by a bipolar storage battery system having the features of claim 1. The bipolar storage battery system comprises a first storage battery unit and a second storage battery unit, as well as a control unit that is shared by both storage battery units.

Each storage battery unit includes at least one storage battery module, and each storage battery module includes at least one storage battery cell, with lithium-ion storage battery cells preferably being considered for storage battery cells.

The shared control unit is intended and configured for ensuring electrical and/or functional safety of the bipolar storage battery system (for example, electrical safety according to IEC 61010-1 or IEC 60664, or functional safety according to ISO 13849-1 or IEC 61508), in particular for appropriate monitoring of each storage battery unit included by the bipolar storage battery system, and/or of the or each storage battery module included by each storage battery unit.

Each storage battery unit as such is a unipolar storage battery unit, and as a two-pole element has an electrically positive pole (positive pole) and an electrically negative pole (negative pole) and corresponding contacts, i.e., contacts at which the particular electrical potential may be tapped.

The two storage battery units are or become connected, in particular electrically connected in series, by means of the corresponding contacts. Due to the connection, a center tap results between the two storage battery units that are connected, in particular connected in series.

For a serial connection, the contacts remaining after the connection to form the center tap, as a positive pole and a negative pole of the storage battery system, are or are to be routed across the control unit to the outside for an external tap as a positive and a negative external terminal.

The center tap, as a neutral pole of the storage battery system, is or is to be routed across the control unit—across the same control unit—to the outside for an external tap as a neutral external terminal.

Due to the three external terminals that are routed in each case across the control unit—across the same control unit—to the outside, the storage battery system is a bipolar storage battery system. The bipolar storage battery system includes, as external terminals, a positive external terminal at which a relatively positive potential can be tapped, a negative external terminal at which a relatively negative potential can be tapped, and a neutral external terminal at which a relatively neutral potential can be tapped. An inverter is preferably connected to the three external terminals of the bipolar storage battery system.

The relatively positive potential is positive in relation to the neutral potential, and the relatively negative potential is negative in relation to the same neutral potential. In the following discussion, the abbreviations “positive” and “negative” are used instead of “relatively positive” and “relatively negative,” respectively.

In US 2006/0071636 A1 mentioned at the outset, only FIG. 1 therein shows a serial connection of two units, referred to therein as batteries, leading to a center tap. The center tap and the contacts remaining after the connection are guided onto a terminal strip, referred to as a terminal block in US 2006/0071636 A1. Apart from the tappability, mentioned therein, of each of the guided potentials, the terminal strip has no function, in any case no function of the type as provided in the invention proposed here in the form of the shared control unit.

One advantage of the storage battery system proposed here is that a comparatively simple design of an inverter or the like connected downstream is possible due to the bipolarity of the storage battery system. In particular for a system manufacturer, who for example combines a bipolar storage battery system of the type proposed here with an inverter or the like, the connection to form the bipolar system is already achieved within the system (as an integral part of the functionality of the bipolar storage battery system), so that the bipolar storage battery system, in a manner of speaking, is usable “out of the box” (immediately ready for use, in particular inspected by the manufacturer or supplier and therefore immediately ready for use).

The system manufacturer not only achieves cost savings resulting from dispensing with the second control unit, which now is no longer needed, but in particular is also relieved of integration efforts (technical design or software, documentation, commercial aspects) which would otherwise be necessary.

A further advantage of the storage battery system proposed here is that in an overall system that is formed with such a storage battery system, for example an overall system that functions as a UPS, SPS, or the like, the two individual sections included by the storage battery system, namely, the first storage battery unit and the second storage battery unit, may be individually started under the control of the shared control unit. The shared control unit, in contrast to known control units, which depending on the system are in each case assigned to exactly one section (the single “section” of a simple unipolar system), takes on further functions that are adapted to the particular situation of the connection. For example, during separate or simultaneous start-up (activation and switching on of the resulting voltage to the external terminals) of the individual sections, the shared control unit monitors and recognizes possible voltage asymmetry, and includes appropriate means, in particular circuit means, for recognizing possible voltage asymmetry. Alternatively or additionally, during separate or simultaneous start-up such a shared control unit checks for possible imminent external error conditions, for example an external short circuit and/or excessively high or faulty input capacitances of the downstream circuit, in particular of an inverter circuit, and includes appropriate means, in particular circuit means, for checking for possible imminent external error conditions. In a particular overall system, for example an overall system that functions as a UPS, SPS, or the like, a substantial portion of a logic system (circuit, firmware, and/or software) previously necessary may be dispensed with.

Yet a further advantage of the storage battery system proposed here is that, due to the exactly one shared control unit for the two storage battery units, communication, otherwise necessary, between two individual, otherwise necessary control units is dispensed with. Such communication is necessary for simultaneous or quasi-simultaneous switching on and off of the storage battery units. When there is exactly one control unit, not only are the communication and the logic system and/or software or firmware, necessary for this purpose, dispensed with, but also there is the advantage that monitoring of the otherwise necessary communication is no longer required.

The proposed bipolar storage battery system having a shared control unit for the two storage battery units included by same is particularly advantageous when lithium-ion storage battery cells are used as storage battery cells. It is absolutely necessary to monitor lithium-ion storage battery cells by means of a control unit for the reasons described above. With the bipolar storage battery system proposed here, this monitoring takes place by means of the shared control unit, i.e., exactly one control unit. For a bipolar storage battery system with a shared control unit for the two storage battery units included by same, the required metrological monitoring of the storage battery cells and the electrical and/or electronic circuit necessary for this purpose are combined in the shared control unit. This avoids otherwise necessary duplicate metrological monitoring.

The invention proposed here further relates to the use of a bipolar storage battery system as described here and in the following discussion for directly feeding a converter system, in particular for directly feeding an inverter for the purpose of generating an alternating voltage by means of the inverter, based on the electrical energy supplied by the bipolar storage battery system, and to a system having a function as an uninterruptible voltage supply or as a substitute power supply, and including a bipolar storage battery system as described here and in the following discussion.

Advantageous embodiments of the invention are the subject matter of the subclaims. Back-references that are used within the claims refer to the further development of the subject matter of the referenced claim by the features of the respective dependent claim. They are not to be construed as a waiver of the attainment of independent subject matter protection for the features or feature combinations of a dependent claim. Furthermore, with regard to an interpretation of the claims and of the description, in the event of a more precise specification of a feature in a dependent claim, it is to be assumed that there is no such limitation in the respective preceding claims or in a more general embodiment of the bipolar storage battery system according to the invention. Accordingly, any reference in the description to aspects of dependent claims is expressly to be construed as a description of optional features, without particular mention. Lastly, it is noted that the claims filed with the present patent application are proposed formulations without prejudice to the attainment of further patent protection.

Since in particular the features of the dependent claims, with regard to the prior art on the date of priority, may form separate, independent inventions, the applicant reserves the right to make these or even further feature combinations, heretofore disclosed only in the description and/or drawings, the subject matter of independent claims or declarations of division.

Moreover, the features of the dependent claims may also include separate inventions that are independent from the subject matter of the respective referenced claims.

One exemplary embodiment of the invention is explained in greater detail below with reference to the drawings. Corresponding subject matter or elements is/are provided with the same reference numerals in all figures.

The exemplary embodiment is not to be construed as limiting to the invention. Rather, within the scope of the present disclosure, supplements and modifications are also possible, in particular those that are apparent to those skilled in the art with regard to achieving the object of the invention, for example by combining or modifying individual features or method steps that are described in connection with the general or specific description section and contained in the claims and/or the drawings, and that by use of combinable features within the scope of the claims result in new subject matter or new method steps or method step sequences.

### BRIEF DESCRIPTION OF THE DRAWINGS

In the figures:

FIG. 1 and

FIG. 2 show a storage battery system, and

FIG. 3 shows an overall system that is formed with a storage battery system according to FIGS. 1 and 2.

### DETAILED DESCRIPTION OF ILLUSTRATED EMBODIMENTS

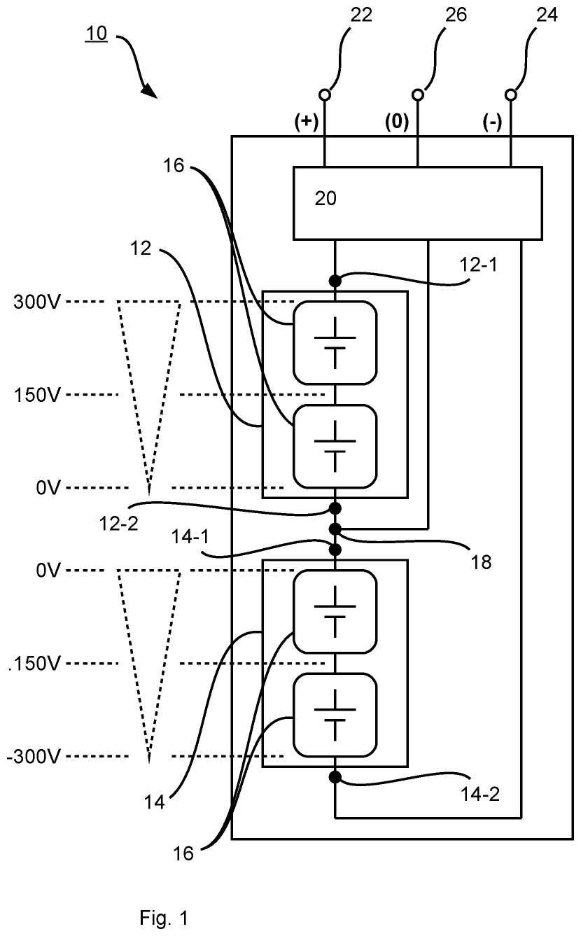

FIG. 1 shows a schematically simplified illustration of one embodiment of the bipolar storage battery system 10 proposed here. The bipolar storage battery system comprises a first storage battery unit 12 and a second storage battery unit 14. The two storage battery units 12, 14 each include at least one storage battery module 16. A symmetrical configuration of the two storage battery units 12, 14 is common, i.e., a configuration in which the two storage battery units 12, 14 each have the same number of storage battery modules 16, each with identical or essentially identical capacity, voltage, and cell chemistry, for example one storage battery module 16 in each case, two storage battery modules 16 in each case, three storage battery modules 16 in each case, etc. Such a symmetrical configuration is a configuration of the storage battery system 10 with electrically symmetrical storage battery units 12, 14, and a storage battery system 10 having such a configuration is a storage battery system 10 with electrically symmetrical storage battery units 12, 14. For a plurality of storage battery modules 16, these storage battery modules are connected inside the respective storage battery unit 12, 14. The voltage values depicted in the illustration in FIG. 1 are strictly by way of example, and are applicable, for example, for the shown serial connection of two storage battery modules 16 in each case, with a respective nominal voltage of 150 V.

Each storage battery unit 12, 14 is electrically a two-pole element, and includes a positive pole and a negative pole and has corresponding contacts 12-1, 12-2; 14-1, 14-2. For a storage battery unit 12, 14 with exactly one storage battery module 16 included by same, the poles/contacts of the storage battery module 16 coincide, at least electrically, with the poles/contacts 12-1, 12-2; 14-1, 14-2 of the respective storage battery unit 12, 14. For a storage battery unit 12, 14 with more than exactly one storage battery module 16 included by same, the storage battery modules 16 are electrically connected, in particular connected in series. Upon connection, the contacts remaining after the connection form, at least electrically, the poles/contacts 12-1, 12-2; 14-1, 14-2 of the respective storage battery unit 12, 14.

Inside the bipolar storage battery system 10, the two storage battery units 12, 14 included by same are also connected. In the embodiment shown, the storage battery units 12, 14 are connected in series by means of the corresponding contacts 12-2, 14-1. The connection, in the present case the serial connection, results in a center tap 18.

The bipolar storage battery system 10 further includes a shared control and switch-off unit (CSU) for the two storage battery units 12, 14, referred to below as control unit 20 for short.

The contacts 12-1, 14-2 of the storage battery units 12, 14 remaining after the connection of the storage battery units 12, 14, i.e., the contacts 12-1, 14-2 of the storage battery units 12, 14 remaining after the connection of the connection of the storage battery units 12, 14 to form the center tap 18, as a positive pole and a negative pole of the storage battery system 10, are routed to the outside for an external tap as a positive external terminal and negative external terminal 22, 24. The center tap 18, as a neutral pole of the storage battery system 10, is likewise routed to the outside for an external tap as a neutral external terminal 26.

The external terminals 22, 24, 26 are each routed across the control unit 20 to the outside, i.e., extend electrically across the control unit 20. Depending on the functionality of the control unit 20, this allows, for example, automatic switching on and/or off of individual or all external terminals 22, 24, 26.

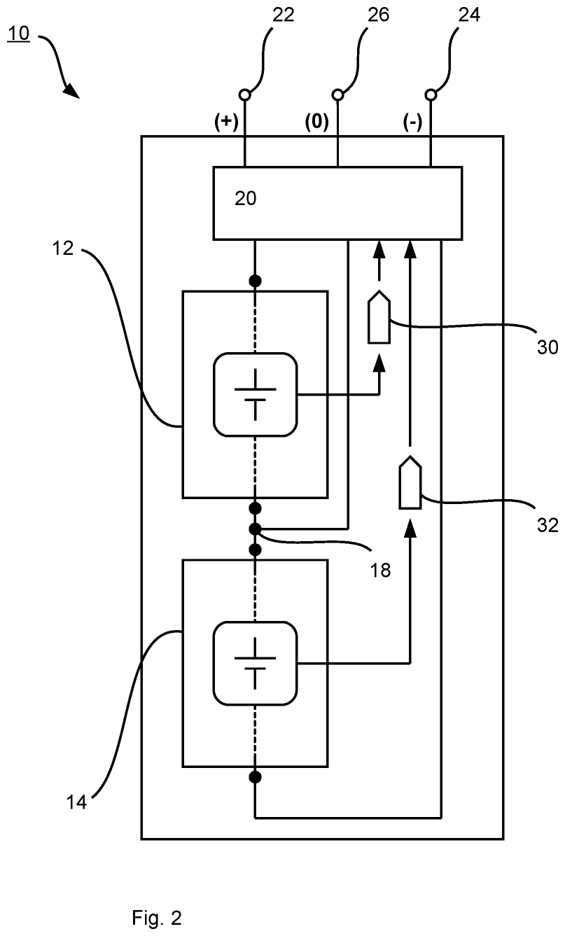

The illustration in FIG. 2 shows the storage battery system 10 according to FIG. 1, but with only some of the reference numerals in the interest of clarity. The control unit 20 is intended and configured for monitoring the storage battery units 12, 14 included by the storage battery system 10, namely, for monitoring the storage battery modules 16 and/or storage battery cells included by same. For this purpose, the storage battery modules 16 each include a sensor system basically known per se, namely, a sensor system for detecting at least one measured current value, a sensor system for detecting at least one measured voltage value, and a sensor system for detecting at least one measured temperature value. The particular measured values (measured current value(s), measured voltage value(s), measured temperature value(s)) are each recorded during operation of the storage battery system 10 and for the particular storage battery module 16 and/or for the at least one storage battery cell included by same. The transfer of these measured values to the control unit 20 takes place, in a manner basically known per se, in the form of data telegrams 30, 32 via a bus, for example a CAN bus, that is included by the storage battery system 10. In the illustration in FIG. 2, such a bus or a comparable bus is indicated by the arrows which include the symbolic illustrations of the data telegrams 30, 32, and which point from a storage battery module 16 (from the or each storage battery module 16 of the storage battery units 12, 14) to the control unit 20. The exactly one control unit 20 included by the storage battery system 10, as a shared control unit 20 for the two storage battery units 12, 14 included by the storage battery system 10, processes the measured values, namely, measured current, voltage, and temperature values, that are included in the data telegrams 30, 32, and thus carries out central monitoring of the storage battery modules 16 included by the two storage battery units 12, 14, and of the storage battery cells that are in turn included by the storage battery modules.

The control unit 20 for the storage battery modules 16 included by the storage battery units 12, 14 and the storage battery cells that are in turn included by the storage battery modules carries out monitoring as follows, in a simplified illustration: The data telegrams 30, 32 include measured values of the above-mentioned type. The control unit 20 compares these, for example, to predefined or predefinable limits, and in the event of a limit violation (exceedance or shortfall) recognizes an error situation and triggers an error response. The data telegrams 30, 32 themselves may also directly include an error message. The control unit 20 then evaluates them and triggers an error response. The control unit 20 optionally carries out a summary review of at least some of the measured values included in the data telegrams 30, 32, for example a summary review (summation) of measured voltage values. The control unit 20 compares the sum resulting from the summary review to a predefined or predefinable limit, for example a limit that is predefined as an expected total voltage of each individual storage battery unit 12, 14, and in the event of a limit violation (exceedance or shortfall) recognizes an error situation and triggers an error response. This limit may be or become predefined as a voltage value. Alternatively, this limit may also be determined by the control unit 20, namely, for example based on a number of storage battery modules 16 in each storage battery unit 12, 14 that is predefined or predefinable for specifying the limit, together with an expected voltage of an individual storage battery module 16 that is likewise predefined or predefinable for specifying the limit. This correspondingly applies for other measured values and corresponding limits, for example current, capacitance, etc., and a corresponding evaluation of such other measured values is optionally additionally or alternatively possible/provided. The error response that is triggered by the control unit 20 for an error situation encompasses switching off the storage battery system 10 and optionally outputting an error message (visual, acoustic, and/or electronic, the latter for example as a data telegram to a higher-level unit). The switch-off of the storage battery system 10 that is triggered as an error response encompasses, for example, switching off the storage battery units 12, 14 included by same and/or the storage battery modules 16 included by same, and/or electrically separating the storage battery units 12, 14 and/or storage battery modules 16 from a downstream circuit, for example an inverter circuit. The control unit 20 automatically carries out the actions described here (comparing, triggering, summing, switching off), and for this purpose includes, in a manner basically known per se, a control program that is implemented in software or in software and firmware with appropriate program code instructions.

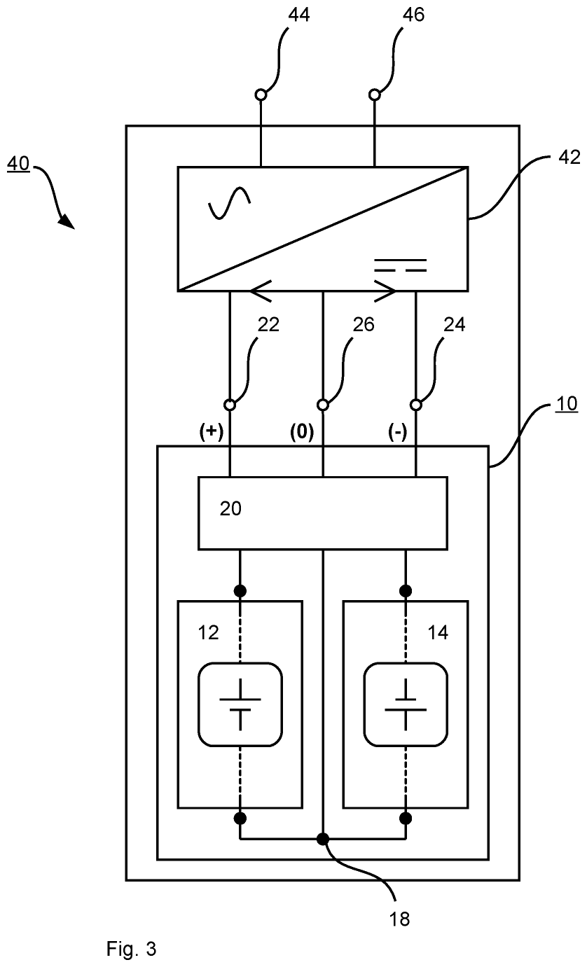

The illustration in FIG. 3 shows a storage battery system 10 of the type proposed here, which in comparison to the illustrations in FIGS. 1 and 2 is slightly modified but electrically equivalent, and in a connection to form a system 40 referred to as an overall system 40, for example an overall system 40 that functions as an uninterruptible voltage supply or as a substitute power supply, for example. The overall system 40 includes, for example, a converter system that is connected to the three external terminals 22-26 of the storage battery system 10, shown by way of example in the form of an inverter 42 (circuit symbols in FIG. 3 according to EN 60617), or the like, in any case a circuit that is connected to all three external terminals 22-26 of the bipolar storage battery system 10. In the overall system 40 shown, which includes an inverter 42, an alternating voltage is tappable at the external terminals 44, 46 (first external terminal 44, second external terminal 46) of the overall system, the electrical energy originating from the bipolar storage battery system 10 and the storage battery cells included by same.

Although the invention has been illustrated and described in detail with reference to the exemplary embodiment, the invention is not limited by the disclosed example(s), and other variations may be derived therefrom by those skilled in the art without departing from the scope of protection of the invention.

Individual key aspects of the description filed here may thus be briefly summarized as follows: A bipolar storage battery system 10 is provided which comprises two storage battery units 12, 14, each including at least one storage battery module 16 and a shared control unit 20 for the two storage battery units 12, 14. The two storage battery units 12, 14 are connected, in particular connected in series, by means of corresponding contacts 12-2, 14-1.

A center tap 18 results from the connection. The contacts 12-1, 14-2 remaining after the connection, as a positive pole and a negative pole, and the center tap 18 as a neutral pole of the storage battery system 10, are in each case routed across the control unit 20 to the outside.

### LIST OF REFERENCE NUMERALS

10 storage battery system
12 storage battery unit
12-1 contact
12-2 contact
14 storage battery unit
14-1 contact
14-2 contact
16 storage battery module
18 center tap
20 control unit
22 (positive) external terminal
24 (negative) external terminal
26 (neutral) external terminal
28 (unassigned)
30 data telegram
32 data telegram
40 system, overall system
42 inverter
44 (first) external terminal
46 (second) external terminal

1. A bipolar storage battery system (10) comprising a first storage battery unit (12) and a second storage battery unit (14), each including at least one storage battery module (16),
wherein each storage battery unit (12, 14) comprises a positive pole and a negative pole and corresponding contacts (12-1, 12-2; 14-1, 14-2),
wherein the two storage battery units (12, 14) are connected in series by means of the corresponding contacts (12-2, 14-1), and a center tap (18) results from the connection,
characterized by
a shared control unit (20) for the two storage battery units (12, 14) comprised by the bipolar storage battery system (10) and intended to ensure electrical and/or functional safety of the bipolar storage battery system (10),
wherein the contacts (12-1, 14-2) remaining after the connection of the two storage battery units (12, 14) to form the center tap (18), as a positive and a negative pole of the storage battery system (10), are routed across the control unit (20) to the outside for an external tap as a positive and a negative external terminal (22, 24), and
wherein the center tap (18), as a neutral pole of the storage battery system (10), is routed across the control unit (20) to the outside for an external tap as a neutral external terminal (26).

2. The bipolar storage battery system (10) according to claim 1,
wherein the shared control unit (20) for the two storage battery units (12, 14) monitors the storage battery modules (16) comprised by the storage battery units (12, 14), and in an error situation automatically switches off the storage battery units (12, 14) and the storage battery modules (16) comprised by same.

3. The bipolar storage battery system (10) according to claim 1 or 2,
in each case including storage battery modules (16) with lithium-ion cells.

4. The bipolar storage battery system (10) according to claim 1, 2, or 3,
including electrically symmetrical storage battery units (12, 14).

5. Use of a bipolar storage battery system (10) according to one of claims 1 through 4 for directly feeding a converter system, in particular for directly feeding an inverter (42), for the purpose of generating an alternating voltage by means of the inverter (42), based on the electrical energy supplied by the bipolar storage battery system (10).

6. A system (40) having a function as an uninterruptible voltage supply or as a substitute power supply, and including a bipolar storage battery system (10) according to one of claims 1 through 4.
